(19) United States
(12) Patent Application Publication
(10) Pub. No.: US 2018/0018702 A1
(43) Pub. Date: Jan. 18, 2018

(54) TIME-DEPENDENT DEMOGRAPHICS FOR DIGITAL BILLBOARDS

(71) Applicant: ENT. SERVICES DEVELOPMENT CORPORATION LP, Tysons, VA (US)

(72) Inventors: Jonathan GIBSON, Austin, TX (US); Shivaprasad VENKATRAMAN, Singapore (SG); Joseph MILLER, Herndon, VA (US); Clifford A. WILKE, Herndon, VA (US)

(73) Assignee: ENT. SERVICES DEVELOPMENT CORPORATION LP, Tysons, VA (US)

(21) Appl. No.: 15/547,778

(22) PCT Filed: Jan. 30, 2015
(86) PCT No.: PCT/US2015/013902

§ 371 Date: Jul. 31, 2017

(51) Int. Cl. G06Q 30/02; G06N 99/00

(52) U.S. Cl. CPC G06Q 30/0266; G06Q 30/0272; G06Q 30/0269; G06N 99/005; G06Q 30/0211; G06Q 30/0252

(57) ABSTRACT

In examples provided herein, a method comprises calling a demographics package to analyze data associated with electronic toll tags used on a toll road along which a digital billboard is positioned to determine time-dependent demographics of drivers of vehicles driven on the toll road. The method also includes calling an advertisement selection package to identify an advertisement to be displayed on the digital billboard, where the advertisement to be displayed is based on the time-dependent demographics of the toll road. Further, the method comprises transmitting the advertisement to be displayed to the digital billboard.

### BACKGROUND

Billboards used for advertising are commonly found in high traffic areas, such as near a highway. Static billboards that provide a static content display have been traditionally used. However, digital billboard displays are now being used more frequently. Digital billboards can be programmed to change the displayed content.

### BRIEF DESCRIPTION OF THE DRAWINGS

The accompanying drawings illustrate various examples of the principles described below, The examples and drawings are illustrative rather than limiting,

FIG. 1 depicts an example environment in which a context-aware platform that links experiences provided to multiple digital billboards as a hyperexperience may be implemented.

FIG. 2A shows a schematic illustration of the operation of an example context-aware platform providing an experience to a billboard.

FIG. 2B shows a schematic illustration of the operation of an example context-aware platform providing coordinated experiences via a hyperexperience to multiple billboards.

FIG. 2C shows a schematic illustration of the operation of an example context-aware platform providing an experience to a user, such as a driver of a vehicle.

FIG. 2D depicts a block diagram of example components an example context-aware platform.

FIG. 3A depicts block diagram of example components of a digital billboard.

FIG. 3B depicts a block diagram of example components of a digital billboard along with an internal sensor and an independent sensor.

FIG. 3C depicts a block diagram depicting an example memory resource and an example processing resource for a billboard engine of a digital billboard.

FIG. 3D depicts an example environment in which a plurality of digital billboards communicate via a network.

FIG. 4A depicts a block diagram of example components of a retail establishment device.

FIG. 4B depicts a block diagram depicting an example memory resource and an example processing resource for a retail establishment device.

FIG. 5 depicts a flow diagram illustrating an example process of providing an experience to a digital billboard by a context-aware platform.

FIG. 6 depicts a flow diagram illustrating an example process of providing an experience to a digital billboard by a context-aware platform.

FIGS. 7A-7C depicts a flow diagram illustrating an example process of determining and applying time-dependent demographics of drivers of vehicles driven on a toll road.

FIG. 8 depicts an example system including a processor and non-transitory computer readable medium of an experience device of a context-aware platform.

FIG. 9 depicts an example system including a processor and non-transitory computer readable medium of an experience device of a context-aware platform.

### DETAILED DESCRIPTION

As technology becomes increasingly prevalent, it can be helpful to leverage technology to integrate multiple devices, in real-time, in a seamless environment that brings context to information from varied sources without requiring explicit input. Various examples described below provide for a context-aware platform (CAP) that may place advertisements having a common theme on multiple context-aware digital billboards, also referred to herein as digital signs, along a toll road based upon analysis of electronic toll tag data to determine time-dependent demographics of drivers of vehicles on the toll road. Examples of vehicles may include automobiles, trucks, trailers, and recreational vehicles. In some implementations, the CAP may provide targeted advertisements and coupons to drivers for redeeming at retail establishments located within a predetermined distance of the driver's vehicle. The targeted advertisements may be based on driver preferences. In some instances, the CAP may also search social media to determine implicit preferences of the driver to provide advertisements and coupons consistent with the driver's preferences.

As used herein, the terms CAP experience and experience are used interchangeably and intended to mean the interpretation of multiple elements of context in the right order and in real-time to provide information in a seamless, integrated, and holistic fashion. In some examples, an experience or CAP experience can be provided by executing instructions on a processing resource.

The CAP experience is created through the interpretation of one or more packages. Packages can be atomic components that execute functions related to devices or integrations to other systems. As used herein, the term package is intended to mean components that capture individual elements of context in a given situation. In some examples, the execution of packages provides an experience. For example, a sensor may collect data, such as weather, environmental, or traffic data, and each sensor may be a package. Examples of environmental data collected by sensors may include humidity, barometric pressure, illumination from the sun and moon. Additionally, each digital billboard may have a standalone experience with the sensors as the packages that provide the data to control the display of the digital billboard based on weather and environmental conditions. Each digital billboard's experience may include receiving specific advertisements for display on the digital billboard based on demographics of the drivers of vehicles on the toll road at particular times. A hyperexperience that ties the experiences of multiple digital billboards together may be provided such that the advertisements displayed on the multiple digital billboards are related or have a common theme. Further, public service information may be provided for display on the digital billboards based on data collected by the sensors on weather, environmental, and traffic conditions.

In some examples, the platform includes one or more experiences that may be provided to a driver of a vehicle to enhance the driver's experiences, or to a digital billboard to provide content applicable to the drivers on the toil road and also based upon driver demographics. The platform may include a plurality of packages that are accessed by various experience devices to provide the experiences. The packages may, in turn, access various information from a user or other resources and may call various services, as described in greater detail below. As a result, the driver or the billboard being provided an experience can be provided with contextual information seamlessly with little or no input from the driver or billboard, respectively. The CAP is an integrated ecosystem that can bring context to information automatically and in the moment. For example, CAP can sense, retrieve, and provide information from a plurality of disparate sensors, devices, and/or technologies, in context, and without input from a user. In one example, a vehicle driver's smartphone, or other networked device associated with the driver of the vehicle or the vehicle itself, may determine and provide the location of the vehicle, and a CAP experience may be provided to the driver that includes advertisements for retail establishments located within a certain range of the vehicle's location that the driver would be interested in, such as restaurants if the time of day coincides with the driver's typical meal times, and restaurants may be selected based on the driver's preferences, either explicit or implicit.

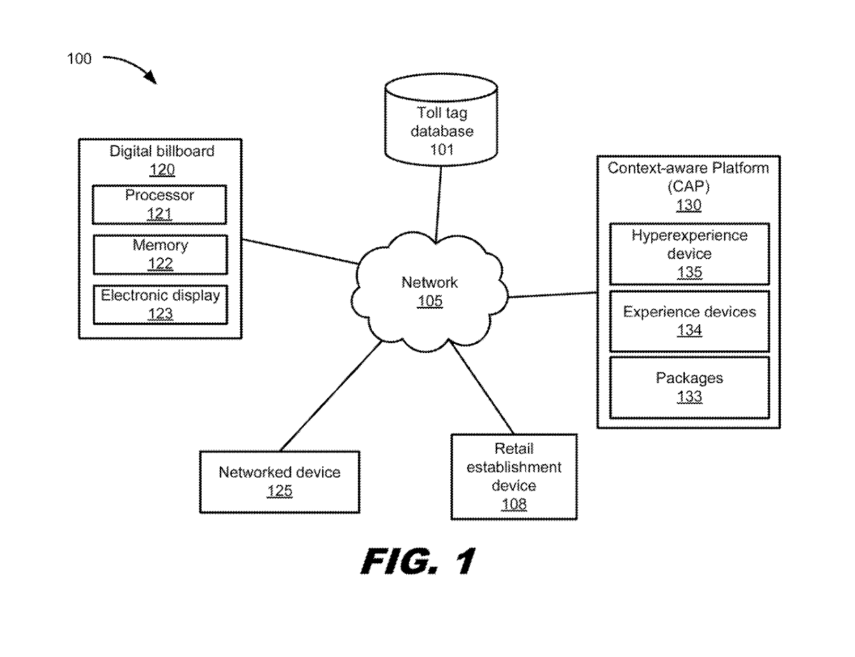

FIG. 1 depicts an example environment 100 in which a context-aware platform (CAP) 130 may be implemented. The CAP 130 may include packages 133 that execute functions, experience devices 134 that call various packages to provide an experience to a digital billboard or a driver of a vehicle, and a hyperexperience device 135 to synchronize experiences provided to multiple digital billboards. As shown in FIG. 1, the CAP 130 may communicate via the network 105 with a toll tag database 101, multiple digital billboards 120 (only one is shown in FIG. 1 for clarity), multiple networked devices 125 (only one is shown in FIG. 1 for clarity), and multiple retail establishment devices 108 (only one is shown in FIG. 1 for clarity). The network 105 may be any type of network, such as the Internet, or an intranet.

The toll tag database 101 stores data and information associated with the users of registered toll tags. Toll tags are devices that have transponders that may be used by registered drivers of vehicles to automatically pay for tolls when passing through toll plazas on a toll road. The day and time when the driver passes through a toll plaza may be collected and stored by a toll tag reader system in the toll tag database 101. Additionally, various data may be collected about the registered drivers and stored in the toll tag database 101 by the agency that runs the electronic toll tag system, such as name; address; car make, model, and license plate; information about other cars and drivers in the family; and e-mail address. Additionally, data associated with electronic toll tags may be cross-referenced with data in other databases and subsequently stored in the toll tag database 101, for example, a database maintained by the department of motor vehicles, to identify other information about the registered drivers, such as age, occupation, car insurance provider, and driving record. Data stored in the toll tag database 101 may be analyzed to determine time-dependent demographics of drivers of vehicles on the toll road.

In some instances, advertisers may wish to purchase advertising time on a single or group of digital billboards for the entire day, every day of the week for a specified duration. However, with the availability of the time-dependent demographics, advertisers have the ability to target a particular driver demographic and purchase advertising time on billboards that coincides with the times that the targeted driver demographic is on the toll road. For example, 70% of the drivers of vehicles on a particular toll road between eight and nine in the morning on a weekday may be between the ages of 20 and 35 years. So an advertiser, such as the owner of a clothing line that targets this age group may, wish to purchase advertising time during this time frame on one or a group of the digital billboards 120. Additionally, an advertiser or a group of advertisers can purchase advertising time on multiple digital billboards with advertisements that are related or have a common theme.

The digital billboards 120 may be positioned to be visible to drivers along a toll road, or a group of toll roads. in some implementations, each of the digital billboards 120 may receive advertisements for display that are independent of advertisements displayed on the other digital billboards 120. In some implementations, two or more of the digital billboards 120 may display coordinated advertisements that are related or share a common theme. For example, the contents of the displays of consecutive digital billboards along a toll road, or even non-consecutive digital billboards, may be linked to tell a story or provide related pieces of information. The digital billboards may also display public service information

Each digital billboard 120 may include a processor 121, a memory 122, and an electronic display 123. In some instances, one of the digital billboards may have a memory to store the advertisements and the public service information for display on the plurality of digital billboards, and the digital billboards are communicatively coupled with each other and the CAP 130.

Networked devices 125 may include any number of portable devices associated with the driver of a vehicle that has a processor and memory and is capable of communicating wirelessly by using a wireless protocol, such as WiFi or Bluetooth. Examples of networked devices include a smartphone, tablet, laptop, smart watch, electronic key fob, fitbit type device, smart glass, and any other device or sensor that can be attached to or worn by a user. Additionally, networked devices 125 may also include devices associated with the vehicle of the driver, such as any device or sensor communicatively coupled to a hotspot of the vehicle that is capable of communicating wirelessly.

Retail establishment devices 108 are devices located at a retail establishment, for example, at a point of sale and integrated with customer relationship management (CRM) systems, to track redemption of electronic coupons provided to the driver of vehicles by the CAP 130.

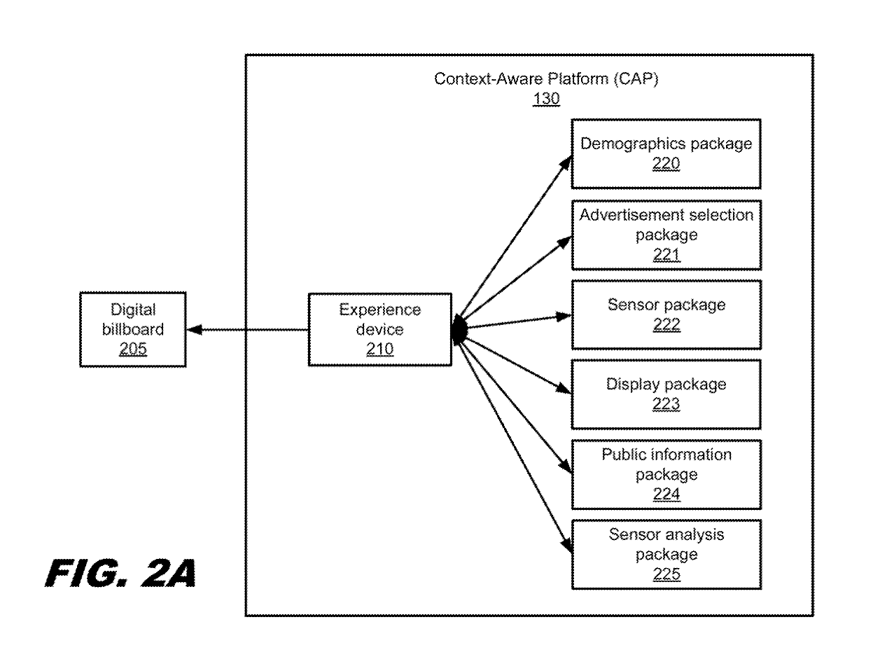

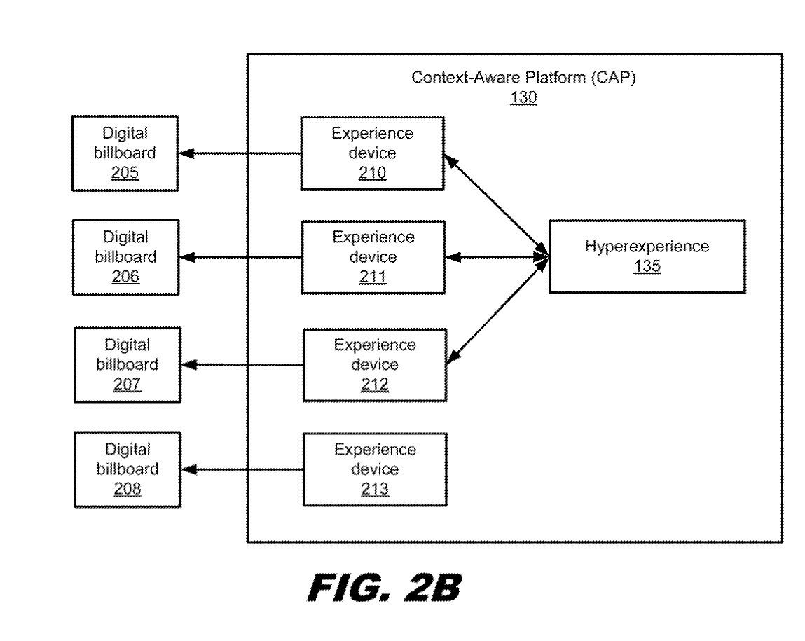

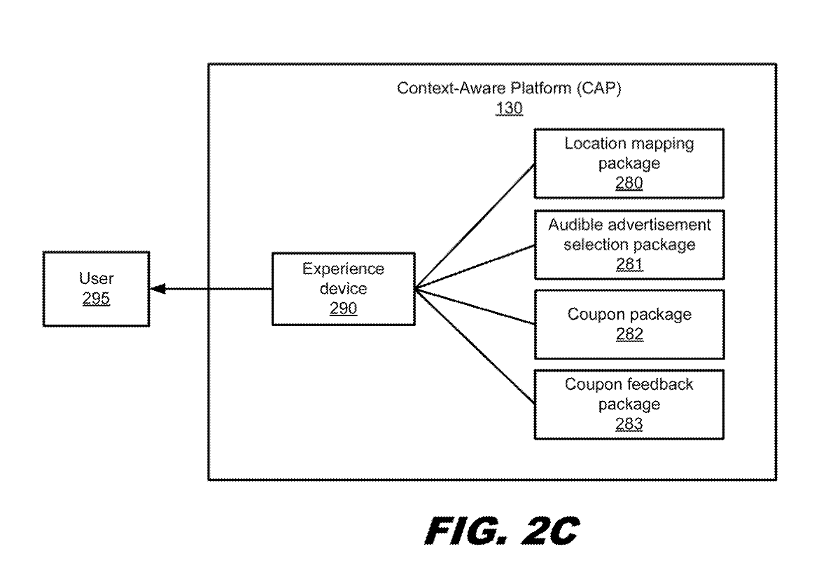

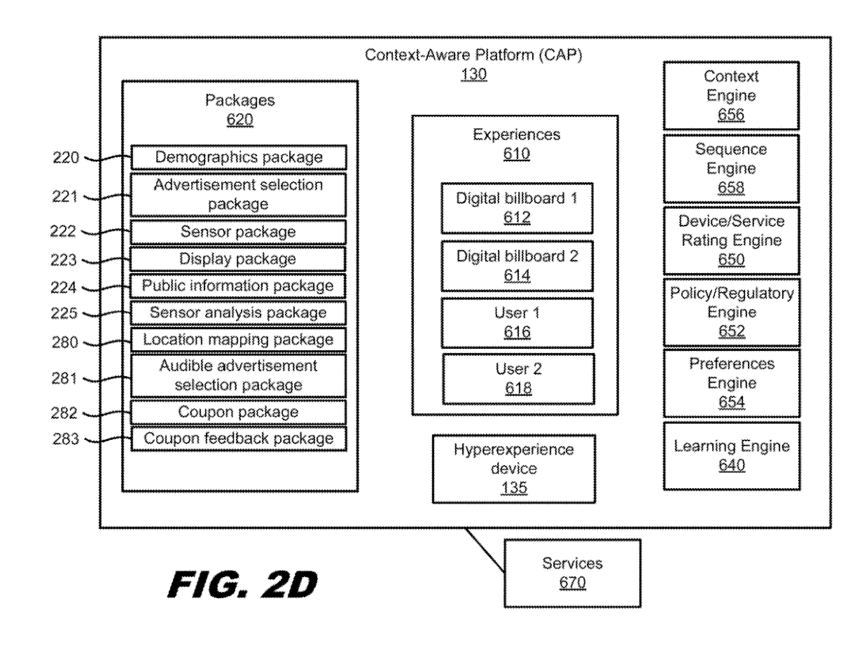

FIG. 2A depicts a schematic illustration of the operation of an example context-aware platform 130 providing an experience to a digital billboard 205. In the example of FIG. 2A, an experience device 210 may call one or multiple packages, such as demographics package 220, advertisement selection package 221, sensor package 222, display package 223, public information package 224, and sensor analysis package 225 to perform their respective functions so that an experience may be provided to the digital billboard 205. The experience device 210 may represent any circuitry or combination of circuitry and executable instructions to provide an experience to a user or a digital billboard, and each package may represent any circuitry or combination of circuitry and executable instructions to perform the package's function.

In the example of FIG. 2A, the demographics package 220 may be called to analyze data stored in toll tag database 101 that is associated with electronic toll tags used on a first toil road along which a first digital billboard is positioned to determine time-dependent demographics of drivers of vehicles driven on the first toll road. In some implementations, the demographic package 220 may cross-reference the data in the toll tag database 101 with other databases, such as a database maintained by the department of motor vehicles or a commercial database to identify additional information about the drivers on the toll road. For example, the demographics package 220 may determine from the data a breakdown by gender and/or age for drivers on the toll road for each hour of the day. In some instances, the demographics package 220 may perform customized demographic analyses upon request by advertisers, for example, a political campaign advertisement may request a breakdown by time of the percentage of drivers on the road who live within a particular voting district.

In some implementations, a driver may opt in to an advertisement program to permit the driver's networked device or other networked device in the driver's vehicle to provide location information for the vehicle to specific advertisers, to advertisers that provide goods or services that fall in specific categories, or to all advertisers. With the opt-in advertisement program, the driver may also provide details, such as interests, frequented sites or types of sites, and frequented events or types of events. Then the advertiser may dynamically provide details for advertisements based on this additional information to be presented on a billboard near the driver's location instead of or in addition to the demographics information derived from data in the toll tag database 101.

The advertisement selection package 221 may be called to identify a first advertisement to be displayed on the first digital billboard, where the first advertisement to be displayed is based on the time-dependent demographics of the first toll road. The advertisement selection package 221 may track and store purchased advertising time on the digital billboards 120 by advertisers for specific advertisements. In some implementations, displays on one or multiple digital billboards 120 may be cycled among multiple advertisements during a specified time period, thus costing an advertiser less than the purchase of an advertisement that is shown continuously for that same time period. For example, advertisement A is shown for one minute, advertisement B is shown for the next minute, and advertisement C is shown for the minute after advertisement B is shown, and the three advertisements are cycled every three minutes for the duration of the specified time period. In these cases, the advertisement selection package 221 may identify the three advertisements for display for the specified time period on a particular digital billboard 120.

The sensor package 222 may be called to retrieve sensor data from a sensor. The sensor package 222 may further be called to control the functions of the sensor. For example, a sensor may be a rain sensor that collects data on how much rain has fallen. By default, the rain sensor may collect data once per day. A corresponding sensor package 222 may adjust the frequency with which the data is collected depending on the season. So during a rainy season, the rain sensor may be adjusted to collect data more frequently, for example, once per hour, so that better resolution data is obtained.

Each sensor may be associated with a particular digital billboard, or with multiple billboards. The data collected by a sensor may include environmental data, weather data, or traffic data. Each sensor that collects data may have a different sensor package that is called to retrieve the sensor data for that particular sensor. In some instances, a sensor may store collected data at a digital billboard that it is associated with, or at another digital billboard that may store data from several sensors In these cases, the sensor package that retrieves data for the sensor may retrieve the data from the memory of the digital billboard that stores the sensor's data.

The display package 223 may be called to determine display parameters for the first digital billboard based on the sensor data from the first sensor. In some implementations, the display package 223 may analyze data collected from more than one sensor to determine display parameters. For example, there may be two illumination level sensors near a digital billboard, one sensor may be in the shadow of a nearby tree, while the other sensor is out in the open. The display package 223 may analyze illumination level data from both sensors to determine an overall illumination level and appropriate display parameters for the digital billboard. Thus, if the environment is bright, for example in the middle of the day with the sun shining and no clouds, the display parameters may maximize the brightness of the digital billboard's display to increase visibility to drivers, but at night with no moon, the brightness of the digital billboard can be turned down to save power, as the digital billboard is still quite visible to drivers at night with minimal brightness.

The public information package 224 may be called to determine whether there is public service information to be displayed. In some implementations, the public information package 224 may monitor news outlets or the weather service for public service announcements, such as the imminent arrival of a strong storm, like a hurricane, or the closure of the toll road or other roads leading to or from the toll road.

In some implementations, the sensor analysis package 225 may be called to determine whether a public service information message should be displayed on part of the digital billboards based on the sensor data retrieved by the sensor packages 222. For example, if a strong thunderstorm or blizzard conditions are detected from weather sensors near a town by the toll road, the drivers of vehicles on the toll road may be alerted to the adverse weather conditions via the digital billboards. Or if a traffic sensor detects that traffic is at a standstill on the toll road, for example, due to a traffic accident that reduces the number of available lanes on the toll road, the traffic conditions may be displayed on part of the digital billboards.

For the example of FIG. 2A, experiences that may be provided to the digital billboard 205 may include any of the following: transmission to the digital billboard 205 of the advertisement to be displayed at the digital billboard 205, where the advertisement selection is based upon time-dependent demographics; transmission of display parameters to the digital billboard 205 for adjusting the electronic display of the digital billboard 205; and transmission of public service information for display on a portion of the digital billboard 205, where the public service information may be based on sensor data

Similar experiences may be provided to other digital billboards through calling the appropriate packages. FIG. 2B depicts a schematic illustration of the operation of an example context-aware platform 130 providing coordinated experiences via a hyperexperience device 135 to multiple digital billboards. In the example of FIG. 2B, experience device 210 provides an experience to digital billboard 205, experience device 211 provides an experience to digital billboard 206, experience device 212 provides an experience to digital billboard 207, and experience device 213 provides an experience to digital billboard 208.

Hyperexperience device 135 may represent any circuitry or combination of circuitry and executable instructions to coordinate and synchronize the experiences provided to multiple digital billboards. In the example of FIG. 28, hyperexperience device 135 coordinates experience devices 210, 211, 212 to provide synchronized experiences to digital billboards 205, 206, 207, respectively, but experience device 213 provides an experience to digital billboard 208 that is independent of the other experience devices 210-212. Thus, hyperexperience device 135 may coordinate the provided experiences such that the digital billboards 205-207 are provided advertisements for display that have a common theme. For example, a watch manufacturer may advertise a particular watch brand in conjunction with a jewelry store's jewelry pieces on digital billboards 205-207 along a toll road that targets adults between 30 and 50 on Friday and Saturday evenings between seven p.m. and midnight. Hyperexperience device 135 ensures that the contents of the advertisements on the digital billboards 205-207 are related, for example, arranged like a storyboard that continues from one digital billboard to the next digital billboard.

FIG. 2C depicts a schematic illustration of the operation of an example context-aware platform 130 providing an experience to a user 295, such as a driver of a vehicle. In the example of FIG. 2C an experience device 290 may call one or multiple packages, such as location mapping package 280, audible advertisement selection package 281, coupon package 282, and coupon feedback package 283.

In the example of FIG. 2C the location mapping package 280 may be called to query and receive a vehicle location from a networked device associated with a driver of a vehicle on a road. The location mapping package 280 may also identify retail establishments within a predetermined distance of the vehicle location.

The vehicle location may be provided in any format, such as latitude and longitude coordinates or an address, such as a toll road mile marker. The location mapping package 280 may further determine the distance of the vehicle location from various retail establishments that are located along the toll road or within a predetermined distance of the toll road, such as five or ten miles. The location mapping package 280 may use a database to determine the types of goods and/or services provided by each retail establishment within the predetermined distance of the vehicle location. Additionally, the identified retail establishments should meet explicit or implicit preferences of the driver. For example, a driver may specify that appropriate nearby restaurants be identified to the driver when the time is 11:30 am, local time. Alternatively, a travel package (not shown) maintained by the CAP 130 may track a travel itinerary for the driver. For example, if the driver flew in from abroad within the last hour, nearby restaurants may be identified to the driver based on the time zone the driver recently flew in from and perhaps the driver's dietary and ethnic preferences based on the time zone the driver originated from.

The audible advertisement selection package 281 may be called to identify an audible advertisement for a retail establishment within a predetermined distance of the vehicle location. Retail establishments may provide advertisements to be presented to drivers of vehicles within the predetermined distance of the retail establishment. Then each retail establishment may pay a fee each time the retail establishment's audible advertisement is provided to the driver of a vehicle.

The coupon package 282 may be called to identify an electronic coupon for redeeming at the retail establishment. A coupon may have an identified expiration time, such as an hour from time of receipt, to encourage the driver to redeem the coupon shortly after notification of transmission of the coupon, in some implementations, particular electronic payment applications, such as Apple Pay or similar payment mechanisms, may be used for redeeming coupons.

The coupon feedback package 283 may be called to perform data analysis on coupon redemption data for the retail establishment. The coupon feedback package 283 may receive coupon redemption information tracked by a retail establishment device at a retail establishment that offers electronic coupons. From the coupon redemption information, transmitted advertisements sent to networked devices of drivers, advertisements transmitted to digital billboards for display, and coupons sent selected by the coupon package 282, coupon feedback package 283 may determine coupon and advertisement effectiveness. The coupon and advertisement effectiveness information allows the retail establishments to determine their return on investment (ROI) and to potentially improve their ROI based on targeted advertising.

For the example of FIG. 2C, experiences that may be provided to a user 295, such as the driver of a vehicle, may include any of the following: determining a location of the vehicle and causing an audible advertisement for a retail establishment to be audibly conveyed to the driver, where the retail establishment meets the explicit and implicit preferences of the driver, and the retail establishment is within a predetermined distance of the vehicle: and transmitting an electronic coupon to the driver via the driver's networked device for redeeming at a retail establishment and causing a networked device to audibly notify the driver of the transmission of the coupon. Further, an experience may be provided to a person associated with a retail establishment regarding coupon redemption data analysis.

FIG. 2D depicts a block diagram of an example context-aware platform (CAP) 130. The CAP 130 may determine which package among multiple available packages 220-225, 280-283 to execute based on information provided by the context engine 656 and the sequence engine 658. In some examples, the context engine 656 may be provided with information from a device/service rating engine 650, a policy/regulatory engine 652, and/or preferences engine 654. For example, the context engine 656 may determine which package to execute based on a device/service rating engine 650 (e.g., hardware and/or program instructions that can provide a rating for devices and/or services based on whether or not a device can adequately perform the requested function, such as the preferred networked device of a plurality of networked devices of the driver to which a coupon is sent), a policy/regulatory engine 652 (e.g., hardware and/or program instructions that can provide a rating based on policies and/or regulations, such as relating to privacy issues), preferences engine 654 (e.g., explicit preferences provided by a user or implicit preferences obtained for the user), or any combination thereof.

Preferences engine 654 may represent any circuitry or combination of circuitry and executable instructions to receive explicit preferences of the driver of a vehicle. For example, a vehicle driver may explicitly provide preferences to the CAP 130 about preferred restaurants and/or types of food, restaurants that the driver is not interested in patronizing, preferred gas stations, and preferred fuel pricing ranges. In some implementations, the preferences engine 654 may determine implicit preferences of the driver. For example, preferences engine 654 may search social media to determine the drivers preferences through blog postings or postings to social media sites. In some implementations, preferences engine 654 may call an external service, for example services 670, to request that a social media searching service perform the social media search and return the results.

In addition, the sequence engine 658 may communicate with the context engine 656 to identify packages 620 to execute, and to determine an order of execution for the packages 620. In some examples, the context engine 656 may obtain information from the device/service rating engine 650, the policy/regulatory engine 652, and/or preferences engine 654 automatically (e.g., without any input from a user) and may determine what package 620 to execute automatically (e.g., without any input from a user). In addition, the context engine 656 can determine what package 620 to execute based on the sequence engine 658.

The packages that make up a digital billboard experience 612, 614 may be synchronized and controlled by the hyperexperience device 135. The context engine 656 determines when, how, and what to display on the electronic display of the digital billboard via the communication network 105 as contextual changes occur, such as localized weather changes, local illumination changes of the sun and/or moon, and changes in the demographics of drivers of vehicles on the toll roads.

After a CAP contextual change, the sequence engine 658 assists the context engine 656 in determining what to display next on an electronic display 315. The policy/regulatory engine 652 may ensure that personal information is protected, and the device/service rating engine 650 may communicate through the network 105 to rate and determine the health of sensors. Additionally, the learning engine 640 may adjust the themes displayed on the digital billboards 120 dynamically as the time of day and time-dependent demographics of vehicle drivers on the toll road changes. The learning engine 640 may also transmit adjusted display parameters to the digital billboards upon changes to the collected sensor data.

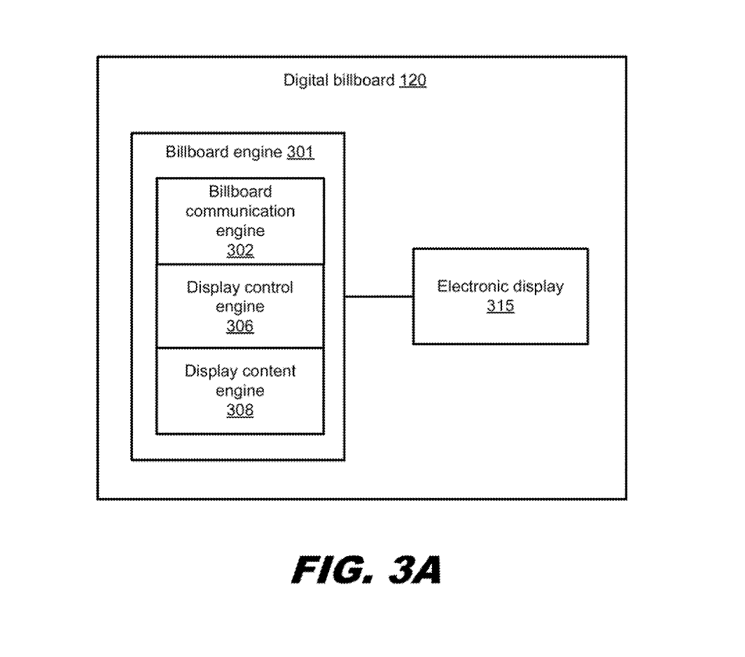

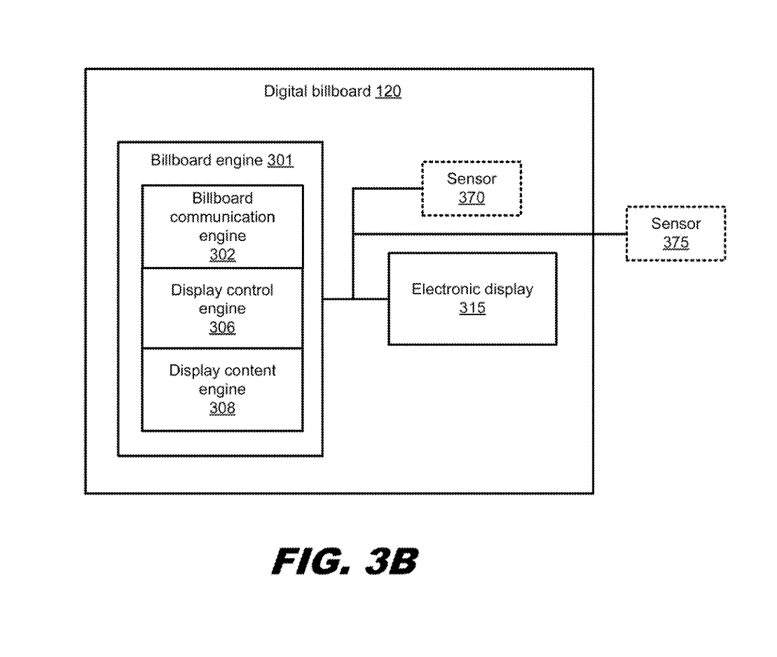

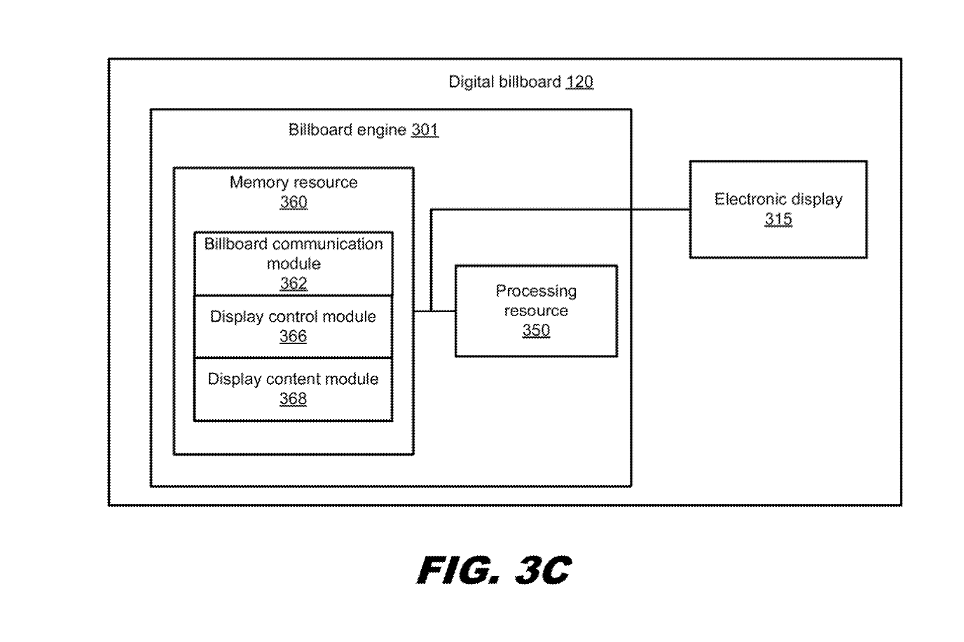

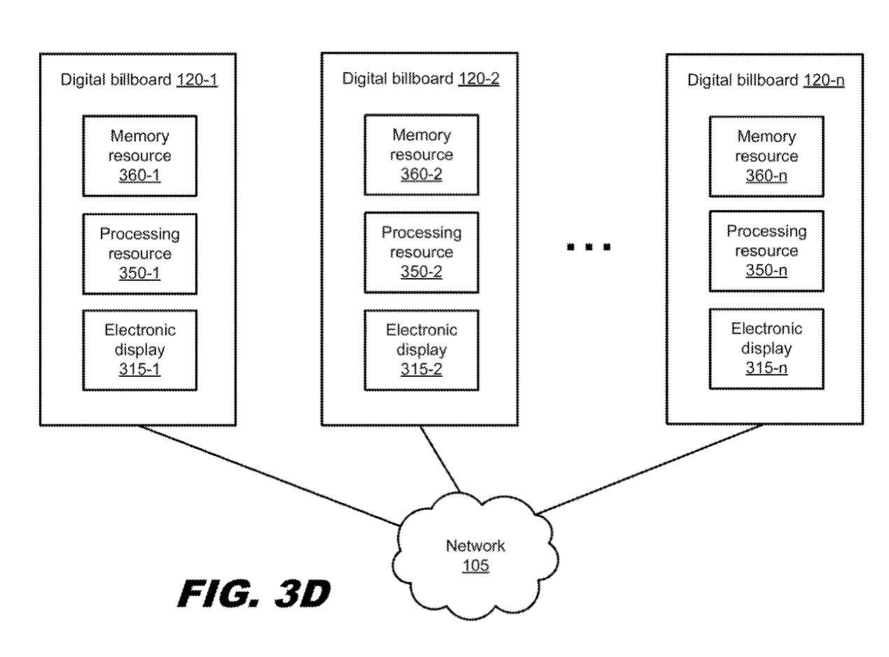

FIG. 3A depicts a block diagram of example components of an example digital billboard 120. The digital billboard 120 may include a billboard engine 301 and an electronic display 315. The billboard engine 301 may include a billboard communication engine 302, a display control engine 306, and a display content engine 308.

In some implementations, as shown in the example of FIG. 3B, the digital billboard 120 may have one or multiple internal sensors 370 that communicate with the digital billboard engine 301. An internal sensor 370 may be embedded within a housing of the digital billboard 120, or may be attached to the exterior of the housing of the digital billboard 120. Alternatively or additionally, one or multiple independent sensors 375 may communicate, wired or wirelessly, with the billboard engine 301. An independent sensor 375 may be physically separate from the digital billboard 120; however, in some cases, an independent sensor 375 may still able to communicate with the digital billboard 120. Additionally or alternatively, in some implementations, the independent sensors 375 may communicate, wired or wirelessly, with the CAP 130 and/or some or all of the billboard engines 301 of other digital billboards 120. Thus, the independent sensors 375 may be positioned within a predetermined distance of one of the digital billboards, for example 100 feet, or one mile, but the independent sensor 375 may be associated with that particular digital billboard and some or all of the other digital billboards. The predetermined distance ensures that the data collected by the independent sensors 375 are relevant to the digital billboards along the toll road. The plurality of internal sensors 370 and independent sensors 375 may collect data that pertains, for example, to weather conditions, environmental conditions, and/or traffic conditions

Billboard communication engine 302 may represent any circuitry or combination of circuitry and executable instructions to receive advertisements and public service information to be displayed on the electronic display 315. The billboard communication engine 302 may also receive coupons and advertisements to be transmitted on to a networked device associated with a driver whose vehicle is within communication distance of the digital billboard 120.

The billboard communication engine 302 may also receive collected data from internal sensors 370 and/or independent sensors 375. In some implementations, the billboard communication engine 302 may represent any circuitry or combination of circuitry and executable instructions to communicate with other billboard communication engines 302 of other digital billboards.

Display control engine 306 may represent any circuitry or combination of circuitry and executable instructions to receive display parameters for controlling the electronic display 315 as part of an experience provided by the CAP 130. Alternatively or additionally, the display control engine 306 may analyze the data received from the internal sensors 370 and/or independent sensors 375, such as weather data and environmental data. Based on the data analysis, the display control engine 306 may adjust the parameters of the electronic display 315. For example, during the night time when the sun is down, and the moon is a crescent moon so that the environment is dark, the brightness of the electronic display 315 may be turned down to save power, whereas if there is precipitation at night, the brightness of the electronic display 315 may be turned higher to ensure that drivers can see the contents of the display.

Display content engine 308 may represent any circuitry or combination of circuitry and executable instructions to display on the electronic display 315 the advertisements and public service information received as part of an experience from the CAP 130. Public service information may be displayed within a dedicated portion of the electronic display 315, such as an area on the bottom or the top of the electronic display 315. If no public service information is to be displayed, the area can remain blank or be used for another purpose. The advertisements may be displayed within the rest of the electronic display 315 at the times purchased by the corresponding advertisers.

In some implementations, the billboard engine 301 may access and be in communication with a database (not shown) that can store data, such as advertisements or public information to be displayed on the electronic display 315, and data collected by sensors 370, 375.

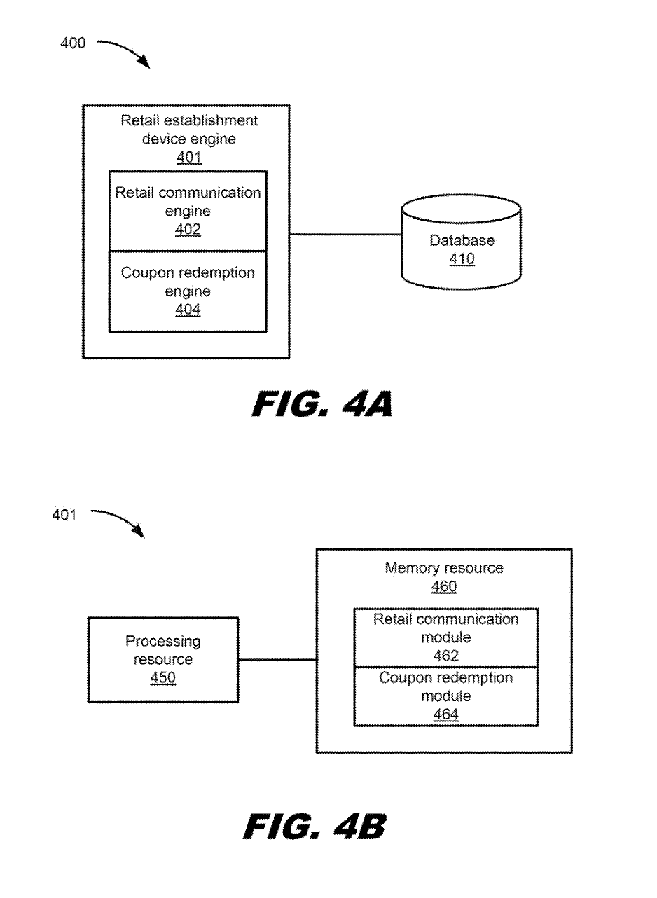

FIG. 4A depicts a block diagram 400 including example components of a retail establishment device engine 401. The retail establishment device engine 401 may include a retail communication engine 402 and a coupon redemption engine 404. Each of the engines 402, 404 may access and be in communication with a database 410.

Coupon redemption engine 404 may represent any circuitry or combination of circuitry and executable instructions to record the date and/or time of redemption of a coupon, coupon identification information, and items that the driver of the vehicle purchased when redeeming the coupon.

Retail communication engine 402 may represent any circuitry or combination of circuitry and executable instructions to transmit the information recorded by the coupon redemption engine 404 to the CAP 130.

Database 410 can store data, such as coupon redemption data, including coupon identification information for redeemed coupons, the date and/or time of redemption of coupons, and other items purchased when the coupon was redeemed.

The examples of engines, such as shown in FIGS. 3A and 4A, are not limiting, as the described engines may be combined or may be a sub-engine of another engine. Further, the engines shown can be remote from one another in a distributed computing environment, cloud computing environment, etc.

Various components in the billboard engine 301 of FIG. 3A and in the retail establishment device engine 401 of FIG. 4A may be combinations of hardware and programming and implemented in different ways. Referring to FIG. 3C, the programming may be processor executable instructions stored on tangible memory resource 360 and the hardware may include processing resource 350 for executing those instructions. Thus, memory resource 360 can store program instructions that when executed by processing resource 350, implements the billboard engine 301 of FIG. 3A. Similarly, referring to FIG. 4B, the programming may be processor executable instructions stored on tangible memory resource 460 and the hardware may include processing resource 450 for executing those instructions. So memory resource 460 can store program instructions that when executed by processing resource 450, implements the retail establishment device engine 401 of FIG. 4A.

Memory resource 360 generally represents any number of memory components capable of storing instructions that can be executed by processing resource 350. Similarly, memory resource 460 generally represents any number of memory components capable of storing instructions that can be executed by processing resource 450 Memory resources 360, 460 are non-transitory in the sense that they do not encompass a transitory signal but instead are made up of one or more memory components configured to store the relevant instructions. Memory resource 360, 460 may be implemented in a single device or distributed across devices. Likewise, processing resource 350 represents any number of processors capable of executing instructions stored by memory resource 360, and similarly for processing resource 450 and memory resource 460. Processing resources 350, 450 may be integrated in a single device or distributed across devices. Further, memory resource 360 may be fully or partially integrated in the same device as processing resource 350, or it may be separate but accessible to that device and processing resource 350, and similarly for memory resource 460 and processing resource 450.

In one example, the program instructions can be part of an installation package that when installed can be executed by processing resource 350 to implement billboard engine 301 in the digital billboards 120 or by processing resource 450 to implement the retail establishment device engine 401. In this case, memory resources 360, 460 may be a portable computer-readable medium such as a compact disc (CD), digital video disc (DVD), or flash drive or a memory maintained by a server from which the installation package can be downloaded and installed. In another example, the program instructions may be part of an application or applications already installed. Memory resources 360, 460 can include integrated memory, such as a hard drive, solid state drive, or the like.

In the example of FIG. 3C, the executable program instructions stored in memory resource 360 are depicted as billboard communication module 362, display control module 366, and display content module 368. Billboard communication module 362 represents program instructions that when executed cause processing resource 350 to implement billboard communication engine 302. Display control module 366 represents program instructions that when executed cause processing resource 350 to implement display engine 306. Display content module 368 represents program instructions that when executed cause processing resource 350 to implement content engine 308.

In the example of FIG. 4B, the executable program instructions stored in memory resource 460 are depicted as retail communication module 462 and coupon redemption module 464. Retail communication module 462 represents program instructions that when executed cause processing resource 450 to implement retail communication engine 402. Coupon redemption module 464 represents program instructions that when executed cause processing resource 450 to implement coupon redemption engine 404.

FIG, 3D depicts an example system including a plurality of digital billboards or signs 120-1, 120-2, . . . , 120-n that are positioned near a toll road. Each digital billboard 120 may include an electronic display 315, a processing resource 350, and a memory resource 360 including instructions executable by the processing resource 350 to receive a plurality of advertisements for displaying on the electronic display 315. The plurality of advertisements may be scheduled for display based on time-dependent demographics of drivers of vehicles driven on the toll road. Also, a first one of the plurality of advertisements displayed on a first digital sign of the plurality of digital signs may have a same theme as a second one of the plurality of advertisements displayed on a second digital sign of the plurality of digital signs. In some implementations, the first one of the plurality of advertisements displayed on the first digital sign and the second one of the plurality of advertisements displayed on the second digital sign may each advertise goods or services of a first vendor and a second vendor.

In some cases, the memory resource 360 includes instructions further executable by the processing resource 350 to adjust parameters of the electronic display 315 based on display parameters received from the CAP, for example, responsive to environmental data, where the environmental data is collected'by environmental sensors.

In some cases, the memory resource 360 may include instructions further executable by the processing resource 350 to receive and display public service information on a portion of the electronic display 315, where the displayed public service information does not interfere with advertisements displayed on the electronic display 315. The public service information may be generated by and transmitted from the CAP 130, where the public service information is based upon data collected by sensors. Alternatively or additionally, the public service information may be generated by a source external to the CAP 130, such as a governmental agency, and received by the CAP 130 for transmitting to the digital billboard's memory resource 360.

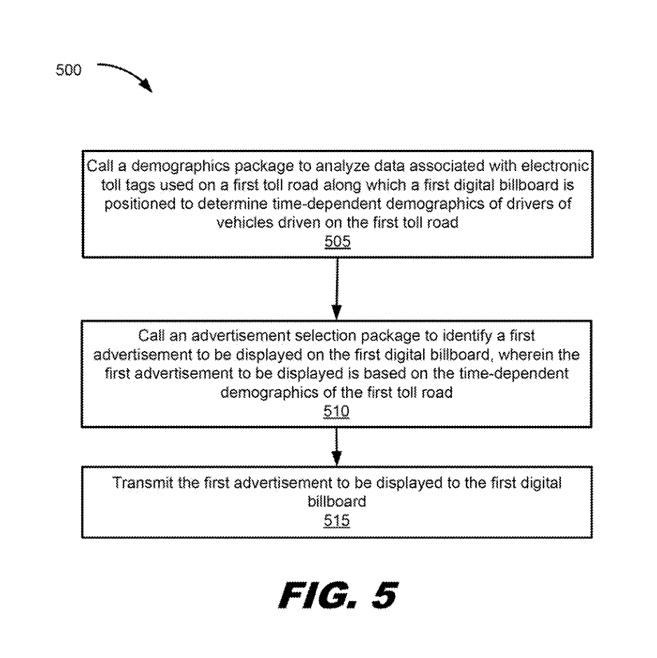

FIG. 5 depicts a flow diagram illustrating an example process 500 of providing an experience to a digital billboard by the CAP. The process begins at block 505 where the CAP may call a demographics package to analyze data associated with electronic toll tags used on a first toll road along which a first digital billboard is positioned to determine time-dependent demographics of drivers of vehicles driven on the first toll road.

At block 510, the CAP may call an advertisement selection package to identify a first advertisement to be displayed on the first digital billboard, wherein the first advertisement to be displayed is based on the time-dependent demographics of the first toll road.

At block 515, the CAP may transmit, via a network, the first advertisement to be displayed to the first digital billboard.

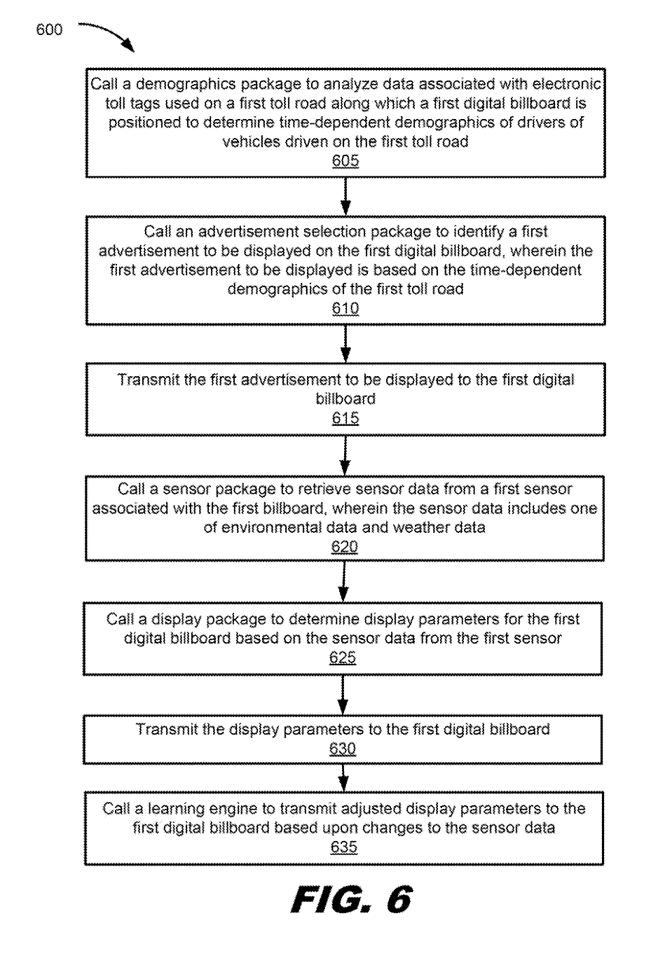

FIG. 6 depicts a flow diagram illustrating an example process 600 of providing an experience to a digital billboard by the CAP. The process begins at block 605, which may be similar to block 505 described with respect to the process 500 of FIG. 5. Block 610 may also be similar to block 510 of FIG. 5, and block 615 may also be similar to block 515 of FIG. 5.

At block 620, the CAP may call a sensor package to retrieve sensor data from a first sensor associated with the first billboard, where the sensor data includes one of environmental data and weather data. Other types of data may also be collected by other sensors, such as biometric data and traffic data.

At block 625, the CAP may call a display package to determine display parameters for the first digital billboard based on the sensor data from the first sensor. Display parameters may include brightness levels for the electronic display, or hue saturation levels. At block 630, the CAP may transmit the display parameters to the first digital billboard.

At block 635, the CAP may call a learning engine to transmit adjusted display parameters to the first digital billboard based upon changes to the sensor data.

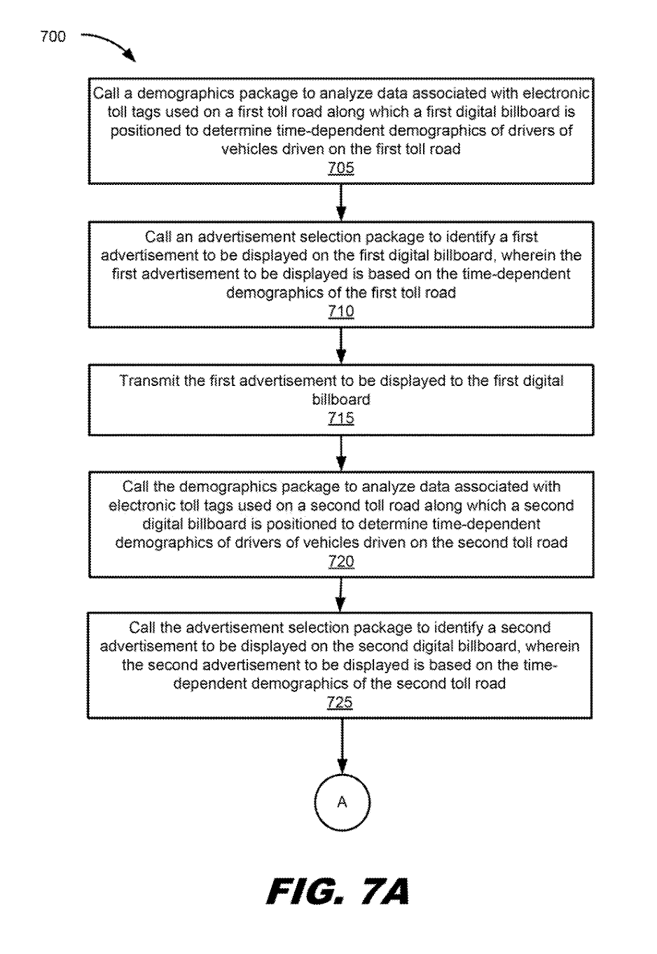

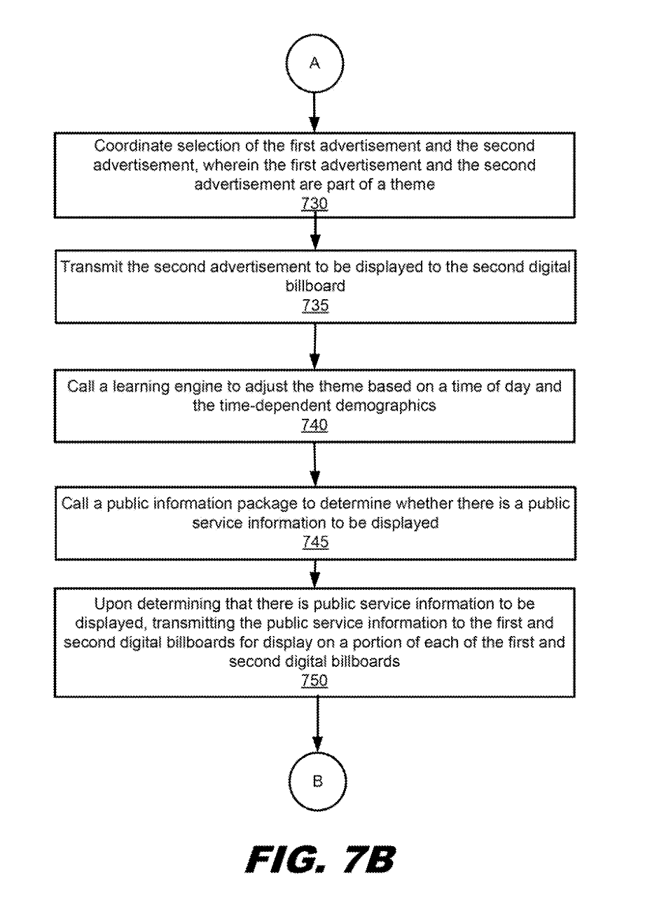

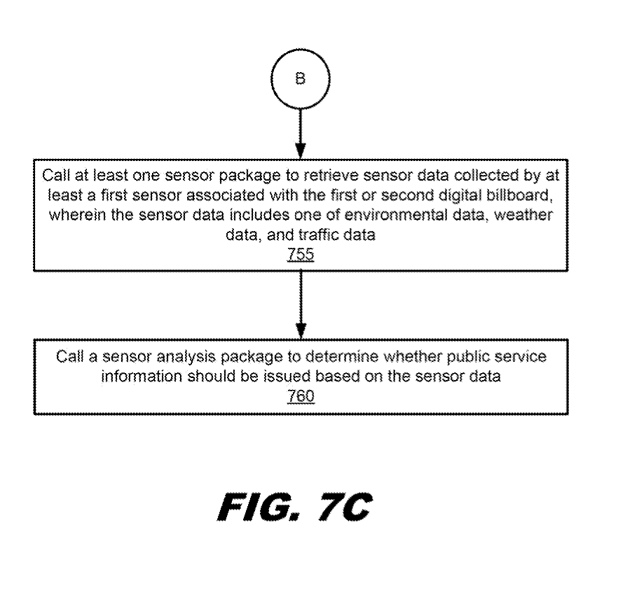

FIGS. 7A-7C depict a flow diagram illustrating an example process 700 of providing a hyperexperience or coordinated experiences to multiple digital billboards by the CAP. The process begins at block 705 which may be similar to block 505 described with respect to the process 500 of FIG. 5. Block 710 may also be similar to block 510 of FIG. 5, and block 715 may also be similar to block 515 of FIG. 5.

At block 720, the CAP may call the demographics package to analyze data associated with electronic toll tags used on a second toll road along which a second digital billboard is positioned to determine time-dependent demographics of drivers of vehicles driven on the second toll road. In some implementations, the second toll road may be the same as the first toll road, and this block may be eliminated.

At block 725, the CAP may call the advertisement selection package to identify a second advertisement to be displayed on the second digital billboard, where the second advertisement to be displayed is based on the time-dependent demographics of the second toll road.

At block 730, the CAP may coordinate selection of the first advertisement and the second advertisement. Coordinated advertisements may be part of a theme, such as sequential elements of a unified storyboard.

At block 735, the CAP may transmit the second advertisement to be displayed to the second digital billboard.

At block 740, the CAP may call a learning engine to adjust the theme based on the time-dependent demographics of the drivers on the toll road or roads as the time of day passes.

At block 745, the CAP may call a public information package to determine whether there is public service information to be displayed. The public service information may be received from an external source such as a local news outlet, local police station, or a weather service, and the public information may pertain to adverse weather conditions, adverse traffic conditions, or other subjects that may be relevant to drivers on the toll road.

At block 750, the CAP may, upon determining that here is public service information to be displayed, transmit the public service information to the first and second digital billboards for display on a dedicated portion of each of the first and second digital billboards.

At block 755, the CAP may call at least one sensor package to retrieve sensor data collected by at least a first sensor associated with the first or second digital billboard, where the sensor data may include one of environmental data, weather data, and traffic data.

At block 760, the CAP may call a sensor analysis package to determine whether public service information should be issued based on the sensor data.

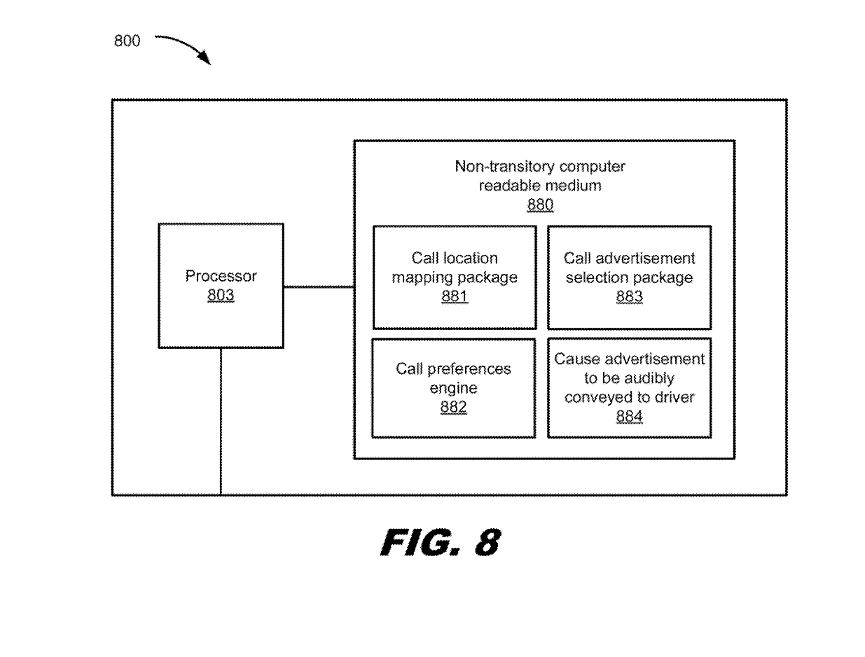

FIG. 8 illustrates an example system 800 including a processor 803 and non-transitory computer readable medium 880 according to the present disclosure. For example, the system 800 may be an implementation of an example system such as experience device 210 of FIG. 2A.

The processor 803 may execute instructions stored on the non-transitory computer readable medium 880. For example, the non-transitory computer readable medium 880 may be any type of volatile or non-volatile memory or storage, such as random access memory (RAM), flash memory, or a hard disk. When executed, the instructions can cause the processor 803 to perform a method of providing an experience to a driver of a vehicle.

The example medium 880 may store instructions 881 executable by the processor 803 to call a location mapping package to query and receive from a networked device associated with a driver of a vehicle on a road, a vehicle location. The networked device may be a mobile wearable device or a mobile device that is coupled to the vehicle of the driver.

The example medium 880 may further store instructions 882. The instructions may be executable by the processor 803 to call a preferences engine to determine explicit and implicit preferences of the driver. Explicit preferences may be provided by the vehicle driver directly to the CAP, while implicit preferences of the driver may be determined through, for example, searches of social media For example, the driver may have posted items on a social media website about liking or disliking certain foods, restaurants, or other retail establishments.

The example medium 880 may also store instructions 883. The instructions may be executable by the processor 803 to call an advertisement selection package to identify an audible advertisement for a retail establishment within a predetermined distance of the vehicle location. Thus, advertisements conveyed to the driver may be selected to be convenient for the driver of the vehicle to reach without going too far out of the drivers intended travel route.

The example medium 880 may further store instructions 884. The instructions may be executable by the processor 803 to cause an audible advertisement for the retail establishment to be audibly conveyed to a driver of a vehicle. The selected retail establishment should meet explicit and implicit preferences of the driver so that the driver is not sent unwanted advertisements. In some implementations, the driver can opt in to advertisements in certain categories, such as fueling stations, service stations, or restaurants, and the driver can select criteria that the retail establishments should meet before an advertisement is conveyed to the driver.

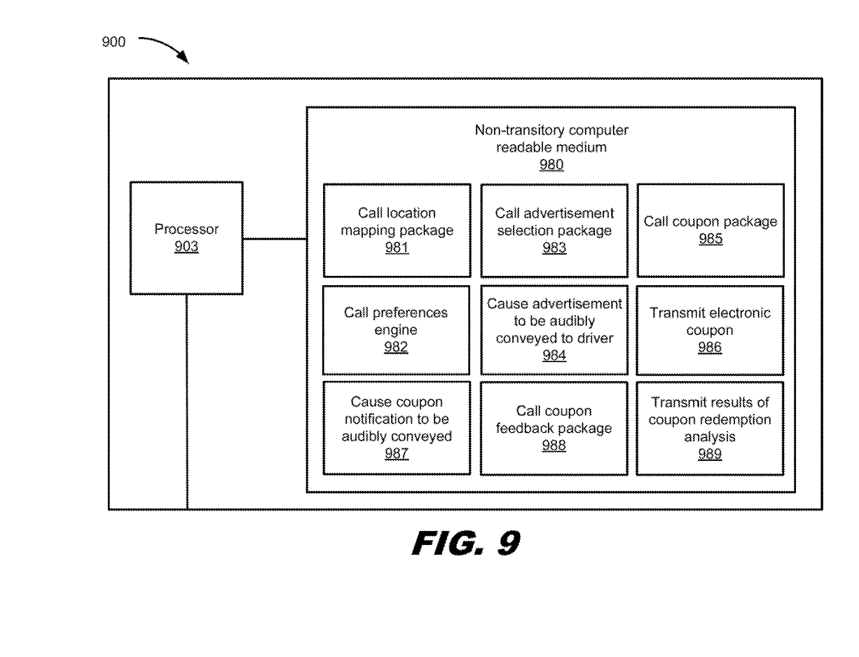

FIG. 9 illustrates an example system 900 including a processor 903 and non-transitory computer readable medium 980 according to the present disclosure. For example, the system 900 can be art implementation of an example system such as experience device 210 of FIG. 2A.

The processor 903 may execute instructions stored on the non-transitory computer readable medium 980. For example, the non-transitory computer readable medium 980 may be any type of volatile or non-volatile memory or storage, such as random access memory (RAM), flash memory, or a hard disk. When executed, the instructions can cause the processor 903 to perform a method of providing an experience to a user who is a driver of a vehicle.

Instructions 981 may be similar to instructions 881 described with respect to the non-transitory computer readable medium 880 of FIG. 8; instructions 982 may be similar to instructions 882 of FIG. 8; instructions 983 may be similar to instructions 883 of FIG. 8; and instructions 984 may be similar to instructions 884 of FIG. 8.

The example medium 980 may store instructions 985 executable by the processor 903 to call a coupon package to identify an electronic coupon for redeeming at the retail establishment.

The example medium 980 may further store instructions 986 executable by the processor 903 to transmit the electronic coupon to the driver via a networked device associated with the driver or with the driver's vehicle. As with advertisements conveyed to the driver, the coupon should meet explicit and implicit preferences of the driver. For example, if the driver is not a smoker, a coupon for cigarettes at a fueling station should not be identified for sending to the driver.

The example medium 980 may also store instructions 987 executable by the processor 903 to cause notification of transmission of the electronic coupon to be audibly conveyed to the driver.

The example medium 980 may additionally store instructions 988 executable by the processor 903 to call a coupon feedback package to perform data analysis on coupon redemption data for the retail establishment, Data analysis results may include information such as redemption percentage.

The example medium 980 may additionally store instructions 989 executable by the processor 903 to transmit results of coupon redemption analysis. The data analysis may be performed in real-time or near real-time, thus results may be communicated to the advertisers and retail establishments in real-time or near real-time, With the results of the data analysis the advertisers and retail establishments may vary coupon value based upon redeemed volume to allow the retail establishments to improve the ROI of advertising budgets.

Not all of the steps, features, or instructions presented above are used in each implementation of the presented techniques. Elements shown in the various figures described above can be added, exchanged, and/or eliminated so as to provide a number of additional examples of the present disclosure.

What is claimed is:

1. A method comprising:
calling a demographics package to analyze data associated with electronic toll tags used on a first toll road along which a first digital billboard is positioned to determine time-dependent demographics of drivers of vehicles driven on the first toll road;
calling an advertisement selection package to identify a first advertisement to be displayed on the first digital billboard, wherein the first advertisement to be displayed is based on the time-dependent demographics of the first toll road; and
transmitting the first advertisement to be displayed to the first digital billboard.

2. The method of claim 1, further comprising:
calling a sensor package to retrieve sensor data from a first sensor associated with the first billboard, wherein the sensor data includes one of environmental data and weather data; and
calling a display package to determine display parameters for the first digital billboard based on the sensor data from the first sensor;
transmitting the display parameters to the first digital billboard.

3. The method of claim 2, further comprising:
calling a learning engine to transmit adjusted display parameters to the first digital billboard upon changes to the sensor data.

4. The method of claim 1, further comprising:
calling the demographics package to analyze data associated with electronic toll tags used on a second toll road along which a second digital billboard is positioned to determine time-dependent demographics of drivers of vehicles driven on the second toil road;
calling the advertisement selection package to identify a second advertisement to be displayed on the second digital billboard, wherein the second advertisement to be displayed is based on the time-dependent demographics of the second toll road;
coordinating selection of the first advertisement and the second advertisement, wherein the first advertisement and the second advertisement are part of a theme: and
transmitting the second advertisement to be displayed to the second digital billboard.

5. The method of claim 4, further comprising;
calling a public information package to determine whether there is a public service information to be displayed;
upon determining that there is public service information to be displayed, transmitting the public service information to the first and second digital billboards for display on a portion of each of the first and second digital billboards.

6. The method of claim 5, further comprising:
calling at least one sensor package to retrieve sensor data collected by at least a first sensor associated with the first or second digital billboard, wherein the sensor data includes one of environmental data, weather data, and traffic data;
calling a sensor analysis package to determine whether public service information should be issued based on the sensor data.

7. The method of claim 4, further comprising:
calling a learning engine to adjust the theme based on a e of day and the time-dependent demographics.

8. A system comprising:
a plurality of digital signs positioned near a tell road, with each digital sign comprising:
an electronic display;
a processing resource; and
a memory resource including instructions executable by the processing resource to:
receive from a context-aware platform (CAP) a plurality of advertisements for displaying on the electronic display,
wherein the plurality of advertisements are scheduled for display based on a determination by the CAP of time-dependent demographics of drivers of vehicles driven on the toll road,
wherein a first one of the plurality of advertisements to be displayed on a first digital sign of the plurality of digital signs has a same theme as a second one of the plurality of advertisements to be displayed on a second digital sign of the plurality of digital signs.

9. The system of claim 8, wherein at least one digital sign further comprises a sensor associated with the digital sign, and wherein the memory resource includes instructions further executable by the processing resource to:
receive display parameters from the CAP; and
adjust the electronic display responsive to the display parameters,
wherein the display parameters are determined by the CAP based upon data collected by the sensor.

10. The system of claim 8, wherein the memory resource includes instructions further executable by the processing resource to:
receive and display on a portion of the electronic display public service information,
wherein the public service information does not interfere with advertisements displayed on the electronic display.

11. The system of claim 8, wherein the first one of the plurality of advertisements displayed on the first digital sign and the second one of the plurality of advertisements displayed on the second digital sign each advertise goods or services of a first vendor and a second vendor.

12. A non-transitory computer-readable medium having instructions stored thereon, the instructions executable by a processor of a context-aware platform (CAP) comprising:
calling a location mapping package to query and receive from a networked device associated with a driver of a vehicle on a road, a vehicle location, and to identify retail establishments within a predetermined distance of the vehicle location;
calling a preferences engine to determine explicit or implicit preferences of the driver;
calling an advertisement selection package to identify an audible advertisement for a retail establishment within the predetermined distance of the vehicle location and meeting driver preferences; and
causing the audible advertisement for the retail establishment to be audibly conveyed to the driver.

13. The non-transitory computer-readable medium of claim 12, wherein the preferences engine searches or causes to be searched social media to determine implicit preferences of the driver.

14. The non-transitory computer-readable medium of claim 12, wherein the instructions are executable by the processor of the GAP and further comprising:
calling a coupon package to identify an electronic coupon for redeeming at the retail establishment;
transmitting the electronic coupon to the driver via the networked device; and
cause to be audibly notify the driver of the transmission of the coupon.

15. The non-transitory computer-readable medium of claim 14, wherein the instructions are executable by the processor of the CAP and further comprising:
calling a coupon feedback package to perform data analysis on coupon redemption data for the retail establishment; and
transmitting results of the coupon redemption data analysis.
